(19) United States
(12) Patent Application Publication
(10) Pub. No.: US 2011/0010509 A1
(43) Pub. Date: Jan. 13, 2011

(54) SYSTEM AND METHOD OF SORTING AND CALCULATING STATISTICS ON LARGE DATA SETS WITH A KNOWN VALUE RANGE

(75) Inventors: Juan Esteban Flores, Owasso, OK (US); Michael O'Neal Fox, Bixby, OK (US); Jim D. Allen, Tulsa, OK (US)

Correspondence Address: Hovey Williams LLP, 10801 Mastin Blvd., Suite 1000, Overland Park, KS, 66210, US

(73) Assignee: L3 Communications Integrated Systems,L.P., Greenville, TX (US)

(21) Appl. No.: 12/498,824

(22) Filed: Jul. 7, 2009

(51) Int. Cl. G06F 12/00

(52) U.S. Cl. 711/154; 711/E12.001

(57) ABSTRACT

A system for sorting data and calculating statistics on large data sets with a known value range includes a memory element and a processing element configured to execute steps of the methods. Methods for sorting data include establishing an array of counters such that each counter corresponds to a value in the data set, reading the numbers and incrementing the counter corresponding to the value of each number, and listing the values in sequential order wherein each value occurs in the list according to the count of the corresponding counter. Methods for calculating statistics utilize the count stored in each counter from the sorted data and the value that corresponds thereto.

### RELATED APPLICATION

The present application is related to co-pending U.S. Patent Application titled “A SYSTEM FOR DETERMINING MEDIAN VALUES OF VIDEO DATA,” Ser. No. 12/340,166, filed Dec. 19, 2008. The identified earlier-filed application is hereby incorporated by reference in its entirety into the present application.

### BACKGROUND OF THE INVENTION

1. Field of the Invention

Embodiments of the present invention relate to statistical data. More particularly, embodiments of the present invention relate to systems and methods for sorting data and determining statistical information on large data sets wherein the range of values of the data is known.

2. Description of the Related Art

Many frequently used applications require a data set to be sorted and/or statistical information, such as the Mean, the Median, the Mode, the Variance, and the Standard Deviation, to be provided for the data. Often, in real world settings, the range of the values of the data is already known. For example, alphanumeric data, which includes the letters of the alphabet and the numerals 0-9, is usually represented in a computer by eight bits of binary data that have a range of values from 0 to 255. Analog signals, such as audio or video, are sampled and converted to a digital representation in order to be stored, broadcast, shared, processed, or otherwise manipulated. The conversion to digital form is generally performed by analog-to-digital converters (ADCs) that have a finite precision or resolution and output a binary number with a fixed number of bits. Thus, for each sample, a 16-bit ADC outputs a number with a range of values from 0 to 65,535.

Often, conventional sorting and statistical techniques are used on data sets with a known value range. These techniques generally have a greater than linear execution growth rate, such as O(n·log n) or O(n²), and may experience computational inefficiencies because they are not optimized to operate on data sets with known value ranges.

### SUMMARY OF THE INVENTION

Embodiments of the present invention solve the above-mentioned problems and provide a distinct advance in the art of data sorting and statistical methods. More particularly, embodiments of the invention provide a system and methods for sorting a data set with a known value range by counting the occurrence of each value within the range. Data sorted with these methods provides a computational advantage when calculating statistics on the data set.

Generally, statistical calculations are performed by implementing a sequence of computations that are executed in iterations, wherein the number of iterations may be related to the number of elements in the data set. With embodiments of the present invention, the number of iterations may be related to the number of values in the data set. Since the number of values is typically much less than the number of elements in the data set, embodiments of the present invention execute statistical calculations much more quickly, as a result of fewer iterations of calculations. Furthermore, due to rounding and other factors, very small inaccuracies may exist in the data after several calculations. These inaccuracies may accumulate and become large with a large number of iterations. Hence, embodiments of the present invention may produce more accurate statistical data as compared with traditional statistical calculation approaches because of fewer iterations of calculations.

The invention may include a system which comprises a memory element and a processing element that are configured to execute steps of the methods for sorting data and calculating statistics on large data sets with a known value range.

The invention may include methods of sorting a data set with n numbers. The steps of a method may include establishing an array of counters such that each counter corresponds to a value in the data set, reading the numbers and incrementing the counter corresponding to the value of each number, and listing the values in sequential order wherein each value occurs in the list according to the count of the corresponding counter.

The invention may further include methods of calculating statistics on data sets, such as the Mean, the Median, the Mode, the Variance, and the Standard Deviation. These methods may utilize the count stored in each counter from the sorted data and the value that corresponds thereto.

Steps of a method to calculate the Mean may include accumulating the product of the count of each counter times the value corresponding to the counter and dividing the accumulated products by the total amount of numbers in the data set.

Steps of a method to calculate the Median may include accumulating the count of each counter in sequential order, comparing the accumulated count with a first quantity after each counter, and determining the value corresponding to the counter when the accumulated count equals or exceeds the first quantity. To find the Median, the first quantity may be equal to n/2.

Steps of a method to calculate the Mode may include comparing the count of all counters to determine the counter with the maximum count, determining the value corresponding to the single counter with the maximum count, and determining the value corresponding to the counter in the middle position of multiple counters with the same maximum count.

Steps of a method to calculate the Variance and the Standard Deviation may utilize the calculation of the Mean and may include determining the difference between each value and the mean, accumulating the product of the difference squared and the count corresponding to each value, dividing the accumulated sum by the total amount of numbers in the data set to calculate the variance, and computing the square root of the variance.

This summary is provided to introduce a selection of concepts in a simplified form that are further described below in the detailed description. This summary is not intended to identify key features or essential features of the claimed subject matter, nor is it intended to be used to limit the scope of the claimed subject matter.

Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a block diagram of a system constructed in accordance with various embodiments of the present invention for sorting data and determining statistical information on large data sets wherein the range of values of the data is known;

FIG. 2 is a block diagram of the system that depicts inputs to the system and outputs of the system;

FIG. 3 is a flow diagram that lists at least a portion of the steps of a method for sorting data;

FIG. 4 is a flow diagram that lists at least a portion of the steps of a method for finding the Kth element;

FIG. 5 is a flow diagram that lists at least a portion of the steps of a method for finding the Mode;

FIG. 6 is a flow diagram that lists at least a portion of the steps of a method for finding the Mean; and

FIG. 7 is a flow diagram that lists at least a portion of the steps of a method for finding the Variance and the Standard Deviation.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

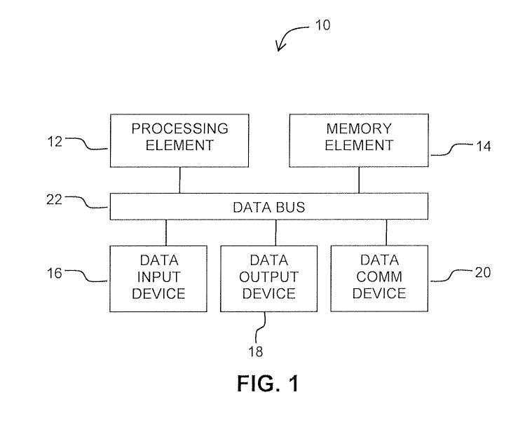

A system 10 for sorting data and calculating statistics on a data set with a known value range, constructed in accordance with various embodiments of the present invention, is shown in FIG. 1. The system 10 broadly comprises a processing element 12, a memory element 14, a data input device 16, a data output device 18, a data communication device 20, and a data bus 22.

The processing element 12 generally performs at least a portion of the steps of the methods of various embodiments of the invention. The processing element 12 may execute instructions or commands that exist in the form of software, firmware, hard-wired components, or combinations thereof. The instructions may also exist as a plurality of code segments to be executed by the processing element 12. The code segments may be grouped or combined to form a computer program. In various embodiments, the computer program may be created from source code using a variety of computer programming languages. The source code may be compiled, translated, interpreted, or the like as is known in the art.

The processing element 12 may be configured to perform arithmetic operations, logical operations, other operations, and combinations thereof. The processing element 12 may be formed from arithmetic units that include adders, multipliers, etc., and logical units that include combinational logic gates among others. The processing element 12 may be further formed from functional blocks such as counters, multiplexers, demultiplexers, shift registers, encoders, decoders, combinations thereof, and the like. In addition, the processing element 12 may include microprocessors, microcontrollers, field-programmable gate arrays (FPGAs), digital signal processors (DSPs), programmable logic devices (PLDs), application specific integrated circuits (ASICs), combinations thereof, and the like. The processing element 12 may be coupled to the data bus 22.

The memory element 14 generally stores instructions, code segments, source code, computer programs, data of any type, combinations thereof, and the like. The memory element 14 may be coupled to the data bus 22. In other embodiments, the memory element 14 may be directly coupled to the processing element 12. In various embodiments, the memory element 14 may include a computer-readable medium. Examples of the computer-readable medium may include latches, flip flops, registers, random access memory (RAM), read-only memory (ROM), programmable ROM (PROM), erasable PROM (EPROM), flash drives, flash memory cards, portable computer diskettes, floppy disks, hard disks, hard disk drives, optical disks, compact disks (CDs), digital video discs (DVDs), Blu-ray Discs, combinations thereof, and the like. In some embodiments, the computer-readable medium may include paper or another suitable medium upon which the computer program is printed, as the program can be electronically captured, via for instance, optical scanning of the paper or other medium, then compiled, interpreted, or otherwise processed in a suitable manner, if necessary, and then stored in the memory element 14.

The data input device 16 generally receives input from a user. The data input device 16 may be coupled to the data bus 22 and may include keypads, keyboards, mice, joysticks, combinations thereof, and the like. The data output device 18 generally outputs data to the user. The data output device 18 may be coupled to the data bus 22 and may include video displays or monitors, audio speakers, printers, combinations thereof, and the like. The data communication device 20 generally allows the system to communicate with other systems or devices. The data communication device 20 may be coupled to the data bus 22 and may include transmitters and receivers that communicate data in a wired fashion through an electric cable or an optical fiber or wirelessly through radio frequency (RF) or similar communication protocols.

The data bus 22 generally provides communication between the components of the system 10. The data bus 22 may include one or more physical communication links of one or more types that are generally coupled together. The data bus 22 may include single signal serial links, multiple signal parallel links, one-way links, bidirectional links, combinations thereof, and the like. The data bus 22 may incorporate electrical, electronic, optical, wireless, or the like forms of communication.

In various embodiments, the system 10 may include desktop computers, laptop computers, workstations, mainframes, handheld devices such as personal digital assistants and cell phones, global positioning system (GPS) devices, video surveillance systems, combinations thereof, and the like.

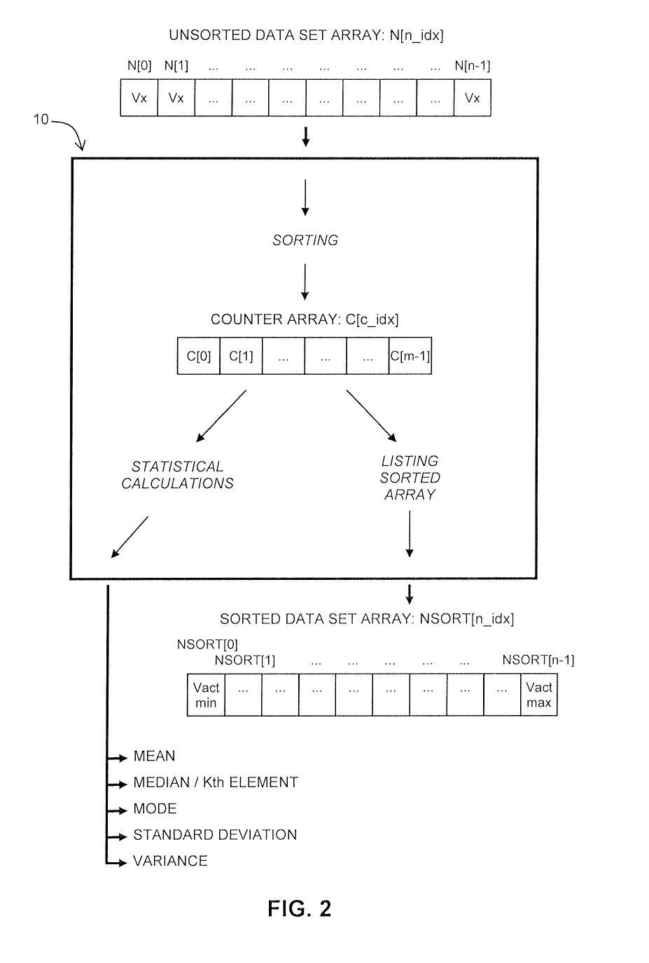

As discussed in greater detail below and shown in FIG. 2, the input to the system 10 may be an unsorted data set of values, Vx, that may be represented as an array, N, with an index, n_idx. Within the system 10, a counter array, C, may be created with an index, c_idx. During sorting, the array of counters, C[c_idx], may be incremented according to the value of the numbers in the data set, N[n_idx]. After sorting is complete, the counter array, C[c_idx], may be used to list the sorted data set as an output, which may be represented by an array, NSORT, with an index, n_idx. The counter array, C[c_idx], may also be used in the statistical calculations to output a Mean, a Median or a Kth element, a Mode, a Standard Deviation, and a Variance.

Methods in accordance with various embodiments of the present invention for sorting data and calculating statistics on a data set with a known value range may be applied to a set of data with integer values. The methods may also be applied to data sets with real number values, given that the range and the precision of the real numbers is finite and known, wherein the precision may correspond to the number of decimal places with which a value is expressed. As a result, there may be a fixed number of real number values.

Generally, once the range of values is known, the data set is sorted by counting the occurrence of each value within the set of data. Thus, a counter, or a register that can be incremented, may be created for every value in the range. The counters may form an array. Each number in the set of data may be read and the counter corresponding to the value of the number is incremented. The counters are arranged by default in a sorted order. Thus, when all the numbers in the data set have been read, then the array of counters represents the data set in a compressed sorted form.

The data set may include n numbers that form the array, N[n_idx], where the index, n_idx, ranges from 0 to n−1. Thus, the data set may include numbers N[0] to N[n−1]. Each number may have a value from Vmin to Vmax. The number of values, m, that exist in the range may depend upon the scaling factor, A, for the data set. The scaling factor for a real value data set may be related to the largest number of decimal places, d, that any number in the data set possesses. The scaling factor, A, may be determined as 10 raised to the power of the number of decimal places: A=10^{d}. The scaling factor, A, for an integer data set (d=0) is A=10⁰=1. In a general form, the number of values, m, in a data set may be expressed as m=(Vmax−Vmin)·A+1. For example, if range of the data set, Vmin to Vmax, is 10.1 to 20.0, then A=10¹=10 and m=(20.0−10.1)·10+1=100.

For every value in the data set, there may be a corresponding counter. An array of m counters may be formed with the notation C[c_idx], where the index, c_idx, ranges from 0 to m−1, yielding counters C[0] to C[m−1]. From the example above, m=100. Therefore, the array of counters is C[0] through C[99].

In some embodiments, the relationship between the value in the data set and the corresponding counter may be one to one correspondence. For example, that the value zero corresponds to counter C[0] and the value 99 corresponds to the counter C[99]. In other embodiments, the relationship between the value and the counter may be mathematical. For example, a scaling multiplier may be used, an additive translation, or some other mathematical relationship. In yet other embodiments the relationship between the value and the counter may be in numerical order, but mathematically unpredictable. For example, value 10 may correspond to counter C[0], the value 11 to C[1], then the value 23 to C[2] in a non-linear jump, the value 27 to C [3], and so forth progressing in numerical order, but without any recognizable pattern.

The above embodiments can all be thought of as mapping methods. A mapping method is a function that maps a value to a corresponding counter (or the index to a counter). Various embodiments of the invention may include a mapping method to relate a given value in the data set to a given counter. Mapping methods may include a reciprocal reverse mapping method that relates a given counter to a given value.

In many embodiments, the calculation of statistical data can be achieved with minimal or no need of mapping or reverse mapping. In the embodiment of a one to one relationship between a value and a counter, no mapping is necessary. In some embodiments, simply mapping at the beginning steps of a calculations and reverse mapping at the ending steps of the calculation results in computational savings because mapping was excluded from all of the steps in between. In yet other embodiments, mapping may be necessary throughout the entire set of steps, in order (for example) to display or list intermediate results of the statistical calculations.

Although any mapping and reverse mapping method may be used by the present invention, for the purposes of clarity, the mapping method (and reverse mapping method) used in the following discussions will include a scaling and translation function, as follows:

In some embodiments, the lowest value of the numbers in the data set may not be zero. Thus, Vmin may be a number other than zero. So in order to relate the index, c_idx, to the actual value, Vmin may be added to the index, c_idx, which may be known as a translation. In addition or as an alternative, the numbers of the data set may be real and may include decimal places. As a result, to determine the corresponding counter for each value in the data set that is read, a scaling and a translation may occur. The counter index, c_idx, may be related to the number, N[n_idx], that is read by the following: c_idx=(N[n_idx]−Vmin)·A. Using the range of values from the example above (A=10, Vmin=10.1), the counter index, c_idx, may relate to the value of the number being read by the equation: c_idx=(N[n_idx]−10.1)·10. To continue the example, the counter corresponding to the value 16.3 may be found from: c_idx=(16.3−10.1)·10=62. Thus, the number of times that the value 16.3 occurs in the data set would be stored in the counter, C[62].

As discussed herein, pseudocode and descriptions thereof are presented for the most general case of data sets where translation and scaling are necessary. However, for the special case where translation and scaling are not necessary, i.e. Vmin=0 and A=1, the pseudocode may be adjusted to eliminate these factors and increase computational efficiency. Thus, in the pseudocode presented below, the terms “Vmin” and “A”, along with the associated mathematical operations, may be removed from the code when considering this special case.

A small data set that may illustrate the methods discussed below is shown here. The data set may include ten numbers with values between 10.1 and 10.5. Thus, n=10, Vmin=10.1, Vmax=10.5, A=10, and m=5. The data set may include: N[0 . . . 9]=[10.4, 10.3, 10.5, 10.1, 10.2, 10.3, 10.5, 10.5, 10.2, 10.1]. Hence, N[0]=10.4, N[1]=10.3, etc. Accordingly, there may be five counters, C[0] to C[4]. Using the relation c_idx=(N[n_idx]−10.1)·10, it can be seen that counter C[0] corresponds to the value 10.1 and counter C[4] corresponds to the value 10.5.

The data set may be sorted by a loop of simple instructions that is executed once for each number in the data set. Hence, sorting of the data occurs on the order of O(n). The sorting may be represented by the following pseudocode expressions:

```
Loop 1: For n_idx = 0 to n−1
    c_idx = (N[n_idx] − Vmin)·A
    C[c_idx] = C[c_idx] + 1
End loop 1
```

As can be seen in Loop 1, each number in the data set is read and the value of the number, once scaled and translated, sets the index of the corresponding counter. That counter is incremented by one. When all n numbers have been read, then the counter array, C[c_idx], represents the numbers in a compressed sorted form, wherein the contents of the counters represent the number of times each value occurs. Using the exemplary data set from above, the Loop 1 index, n_idx, may range from 0 to 9, and the counter array, C[c_idx], may be expressed as: C[0]=2, C[1]=2, C[2]=2, C[3]=1, and C[4]=3.

In some cases, the minimum and maximum values Vmin, Vmax, of the range may not be included in the data set. For example, test scores may range from 0 to 100, although no test may actually receive a score of 0 or 100. In such cases, the actual minimum and maximum values, Vactmin, Vactmax, can be found by setting Vactmin and Vactmax to a certain value and then comparing them to each number in the data set. The following pseudocode expressions may be added to the pseudocode listed above, just before the “End loop 1” statement:

```
If (N[n_idx] < Vactmin)
    Vactmin = N[n_idx]
If (N[n_idx] > Vactmax)
    Vactmax = N[n_idx]
```

From the exemplary data set above, Vactmin=Vmin=10.1 and Vactmax=Vmax=10.5.

The expanded and sorted data set may have the array notation NSORT[n_idx] and may include n elements with the index of the array, n_idx, ranging from 0 to n−1. The sorted array may be created by assigning the index of the non-zero counters in the counter array to each element of the sorted array based on the value of each counter. The first non-zero counter may be known from the steps above to determine Vactmin. The sorted array may be created using the following pseudocode expressions:

```
c_idx = (Vactmin − Vmin)·A
icount = C[c_idx]
Loop 2: For n_idx = 0 to n−1
    While icount == 0
        c_idx = c_idx + 1
        icount = C[c_idx]
    End While
    NSORT[n_idx] = c_idx/A + Vmin
    icount = icount − 1
End loop 2
```

As can be seen, the index of the counter array, c_idx, is set to the first non-zero counter as determined from the actual minimum value, Vactmin, after translating and scaling. A secondary variable, icount, is established to keep track of the contents of each counter, C[c_idx]. In Loop 2, each element of the sorted array, NSORT[n_idx], is assigned to the index of the counter, c_idx, after the index is scaled and translated to the appropriate corresponding value of the data set. The variable, icount, is decremented to count down the contents of each counter, C[c_idx], which represents the number of times each value occurred in the data set. Thus, when the count of the variable, icount, reaches zero, the next non-zero counter is sought, as seen in the “While” loop from the pseudocode. The variable, icount, is reset and again counts down until all the appropriate sorted values are assigned to the sorted array.

Using the exemplary data from above, the count index, c_idx, may be initially assigned: (Vactmin−Vmin)·A=(10.1−10.1)·10=0. The variable, icount, may be consistently assigned the value of each counter, C[c_idx], beginning with C[0]. Thus, the variable, icount, is assigned a value of 2. Loop 2 executes while n_idx ranges from 0 to 9. Since the variable, icount, is not equal to zero, the “While” loop is skipped and the sorted array, NSORT[n_idx], is assigned the actual value that corresponds to the counter index, c_idx, after scaling and translating. The “While” loop executes when the variable, icount, decrements to zero and the next non-zero value of the counters, C[c_idx], is found. After Loop 2 executes, the sorted array may be given as: NSORT[0 . . . 9]=[10.1, 10.1, 10.2, 10.2, 10.3, 10.3, 10.4, 10.5, 10.5, 10.5].

In general, there may be some interest in reporting values that were not present in a given data set. Embodiments of the present invention allow for this situation. The following pseudocode may be added after Loop 2 from above:

```
Loop 2A: For c_idx = 0 to m−1
    If C[c_idx] == 0 then
        Print c_idx/A + Vmin
    End if
End Loop 2A
```

As seen in Loop 2A, if the counter for a given index, C[c_idx], equals zero (indicating that a value was not present in the data set), then the actual value corresponding to the index is printed.

Statistical information, such as the Mean, the Median, the Mode, the Variance, and the Standard Deviation, may be easily calculated using the compressed sorted data in the counter array, C[c_idx]. The Mean may be given as the sum of all the values in the data set divided by the number of values in the data set. The Median may be given as the value of the number that is midway through the distribution of the sorted array. However, the Median may be considered a special case of the Kth element of the distribution, where K=n/2, for a data set with n numbers. In general, the Kth element may be the value of the number that is in any position in the distribution of the sorted array. The Mode may be given as the value of the number in the data set that occurs the most. In the case that more than one value occurs the same number of times, then the median value or the middle number may be considered the mode. The Variance may be given as the sum of the squares of the difference between each value and the mean, wherein the sum is divided by the number of samples. The Standard Deviation may be given as the square root of the Variance.

In general, the counter array, C[c_idx], is scanned in a loop to perform at least a portion of the statistical calculations discussed above. The array may be scanned from the actual minimum value, Vactmin, to the actual maximum value, Vactmax, in situations where the full range of values is not used. The basic loop to scan the counter array, C[c_idx], may be implemented as shown in the pseudocode below. The steps for calculating the various statistics may be added separately, in combinations, or all at once, as discussed in more detail below.

Loop 3: FOR c_idx = (Vactmin − Vmin)·A to (Vactmax − Vmin)·A
icount = C[c_idx]
End Loop 3

The code shown in Loop 3 establishes a variable, icount, similar to above, that tracks the contents of each counter in the array, C[c_idx]. The variable, icount, may be used in other segments of pseudocode for calculating various statistics.

The Mean may be calculated by the following pseudocode to be inserted into Loop 3, just before the “End Loop 3” statement:

SumOfValues=SumOfValues+(c_idx/A+Vmin)·icount

The variable, SumOfValues, accumulates the total of all the numbers in the data set. Since the counter array, C[c_idx], stores the number of times each value occurs, the summation may be shortened by multiplying the value (which is the index, c_idx, after it is scaled by A and translated by Vmin) by the count (stored in icount). The calculation of the Mean may be concluded by dividing the total, SumOfValues, by the amount of numbers, n, in the data set. The calculation may be given by the following expression, executed after Loop 3 is complete:

Mean=SumOfValues/n.

Using the exemplary data set from above, c_idx ranges from 0 to 4. During the first iteration of Loop 3, the variable SumOfValues equals 0 and the variable, icount, is assigned the value of counter, C[0], which equals 2. Therefore, after the first iteration of Loop 3, SumOfValues=0+(0/10+10.1)·2=20.2. The subsequent iterations of Loop 3 may continue in like fashion. After Loop 3 has finished, the variable SumOfValues equals 103.1. Thus, the Mean=SumOfValues/n=103.1/10=10.31.

The Kth element, which may be utilized to find the Median, may be calculated by the following pseudocode to be inserted into Loop 3, just before the “End Loop 3” statement:

```
If Kfound = FALSE
    Kcount = Kcount + icount
    If Kcount >= K
        KthElement = c_idx/A + Vmin
        Kfound = TRUE
    End If
End If
```

A Boolean variable, Kfound, is initialized to be FALSE, and checked each time through Loop 3, such that once the Kth element is found and Kfound is asserted to be TRUE, then the statements following no longer execute. A variable, Kcount, accumulates the contents of each counter, as assigned to icount. Another variable, K, is initialized outside of Loop 3 to be the value of interest, or the “Kth element”. When K is assigned to be n/2, then the Kth element is the Median. When the accumulated value of Kcount is equal to or exceeds the value of K, then the Kth element has been found and the variable, KthElement, is assigned the index of the counter, c_idx, after the index is scaled and translated. The variable, Kfound, is assigned to be TRUE, and the listed instructions are no longer executed.

In various embodiments, the present invention may calculate the mathematical median of the data set when the data set includes an even number of elements. In such instances, the mean, or average, of the two middle elements of the sorted data set (NSORT[N/2], NSORT[N/2+1]) may be calculated as the median. Thus, the median may equal: (NSORT[N/2]+NSORT[N/2+1])/2.

Using the exemplary data set from above, the Median may be determined by setting K=n/2=10/2=5. During the first iteration of Loop 3, Kcount=0 and icount=2. Thus, Kcount=0+2=2. Accordingly, Kcount is not equal to or greater than K, for which K=5. As a result, Loop 3 iterates a couple of more times until Kcount=6. Hence, Kcount is greater than K and consequently the variable, KthElement, equals c_idx/A+Vmin=2/10+10.1=10.3. The variable, Kfound, is assigned to be TRUE, and therefore the pseudocode statements to find the Kth Element no longer execute.

The Mode may be calculated by the following pseudocode to be inserted into Loop 3, just before the “End Loop 3” statement:

```
If icount > ModeMaxCount
    ModeMaxCount = icount
    EqualModeIndex = 0
    ModeBin[EqualModeIndex] = c_idx/A + Vmin
    EqualModeIndex = EqualModeIndex + 1
Else If icount == ModeMaxCount
    ModeBin[EqualModeIndex] = c_idx/A + Vmin
    EqualModeIndex = EqualModeIndex + 1
End If
```

The calculation of the Mode may begin by checking the value of icount (that represents each counter in the array, C[c_idx]) against a variable, ModeMaxCount, which may track the maximum count and may be initialized to zero. If icount is greater than ModeMaxCount, then the current counter, as stored in icount, is the maximum count and is assigned to ModeMaxCount. An array, ModeBin[EqualModeIndex], that stores multiple instances of the Mode, if they exist, receives the value of the number with the maximum count, and the index, EqualModeIndex, is set to zero. In order to obtain the proper value corresponding to the counter index, c_idx, the counter index, c_idx, is scaled and translated by the expression: “c_idx/A+Vmin” and the index, EqualModeIndex, is incremented. Otherwise, if the value of icount is equal to ModeMaxCount, then there may be more than one potential Mode. The value of the number with the equivalent maximum count is stored in the array, ModeBin[EqualModeIndex] and the index, EqualModeIndex, is incremented.

To complete the calculation of the Mode, the following pseudocode may be executed just after Loop 3:

Mode=ModeBin[EqualModeIndex/2]

After all the elements of the counter array, C[c_idx], have been read and compared, then the Mode may be determined by finding the middle element of the Mode array. The index, EqualModeIndex, is divided by 2 to find the middle element of the array ModeBin[EqualModeIndex]. If there is only one Mode, then the index, EqualModeIndex, is zero, which when divided by 2 returns ModeBin[0], thereby determining the proper Mode. If there is an even number of elements in the ModeBin array, then there are two middle elements in the array. So, dividing the index, EqualModeIndex, by 2 generally returns the middle element that is closer to Vmax, rather than Vmin. Some embodiments may return the middle element that is closer to Vmin. Other embodiments may return the value that is the average of the two middle elements of the ModeBin array.

Using the exemplary data set from above, the first time through Loop 3, the variable, icount, equals 2, which is greater than ModeMaxCount, which was initialized to zero. Accordingly, ModeMaxCount is assigned the value of icount, EqualModeIndex is set to 0, and the first element of the ModeBin array is assigned the value of the number corresponding to the counter index, c_idx. During the second and third times through Loop 3, C[1] and C[2] both=2 and in turn, icount=2. Hence, the “Else” portion of the code is executed, such that after the third iteration, EqualModeIndex=2 and there are three elements of the ModeBin array, ModeBin[0 . . . 2], where ModeBin[0]=10.1, ModeBin[1]=10.2, and ModeBin[2]10.3. On the fifth iteration of Loop 3, icount=3, which is greater than ModeMaxCount, which currently=2. Thus, ModeMaxCount is set to 3, EqualModeIndex is set to 0, and the first element of the ModeBin array is reset to the value with the greatest number of occurrences: ModeBin[0]=10.5. Then, the EqualModeIndex is incremented. After the fifth iteration, Loop 3 no longer executes and the Mode is finally determined by the relationship: Mode=ModeBin[EqualModeIndex/2]=ModeBin[1/2]=10.5.

The Variance may be calculated by utilizing the Mean that is discussed above. Thus, the following pseudocode may be executed after the Mean is calculated:

```
Loop 4: FOR c_idx = (Vactmin − Vmin)·A to (Vactmax − Vmin)·A
    Diff = (c_idx/A + Vmin) − Mean
    Variance = Variance + (Diff·Diff)·C[c_idx]
End Loop 4
Variance = Variance / (n−1)
```

The calculation of the Variance may include determining the difference between each number in the data set and the Mean of the values. The actual value of each number may be found be scaling and translating the counter index (c_idx/A+Vmin). The calculation of the Variance further includes summing the squares of the differences. This portion of the calculation may be shortened by taking advantage of the fact that the number of times each value occurs is known. The square of the difference for each value may be multiplied by the number of times each value occurs—which is stored as the contents of each counter, C[c_idx]. Thus, Loop 4 may iterate m times (once for each value in the range of numbers), as opposed to n times (once for each number in the data set). A significant savings may occur, as m is generally much smaller than n. The calculation of the Variance may conclude by dividing the sum by the size of the data set, n, minus one. The subtraction may be included as a correction to the calculation when the data set represents a sample taken from a larger population. Other embodiments may finish the calculation by dividing the sum by the size of the data set, n.

Using the exemplary data set from above, Loop 4 executes while the counter index, c_idx, varies from 0 to 4. During the first iteration of Loop 4, Diff=(0/10+10.1)−10.31=−0.21. The variable Variance=0+(−0.21·−0.21)·2=0.0882. The rest of the iterations of Loop 4 continue in a like fashion. The Variance is finally calculated by the relation: Variance=Variance/(n−1)=0.229/9=0.025.

The Standard Deviation may be calculated by utilizing the Variance, discussed above. Thus, the Standard Deviation may be calculated after the computation of the Variance is complete, and may be given as the square root of the Variance. A pseudocode statement for the Standard Deviation may be shown below:

StdDev=sqrt(Variance)

The square root function may be indicated as “sqrt”. Using the exemplary data set from above, the Standard Deviation may be expressed as: sqrt(0.025)=0.159.

In some embodiments, an arbitrary subset of values may exist because not every value in the range of values is present in the data set. If the specific values are known, then some calculation time may be saved by creating counters only for the values that are known to be present. If the subset includes a linear pattern of numbers, such as only even numbers or only odd numbers, then a mapping and reverse mapping similar to the ones shown above may be used as described above. If the numbers of the subset are nonlinear or random in nature, then the mapping and reverse mapping may be more complex than shown above and may involve the use of lookup tables or other mapping techniques. The tradeoff between the time and resources saved in performing calculations versus the time and resources required for mapping would have to be considered before taking this approach.

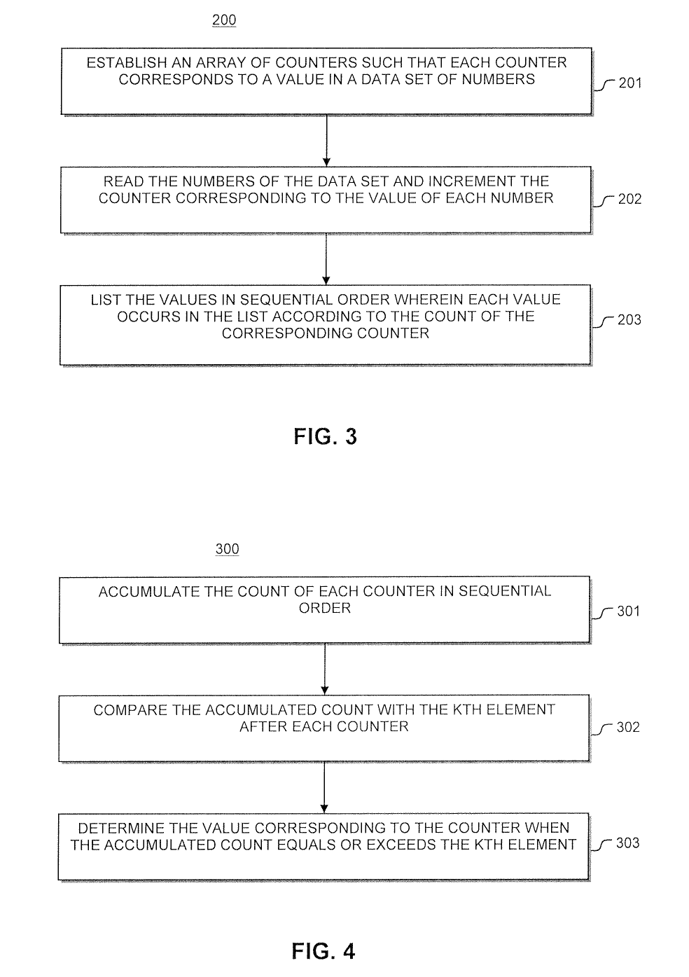

At least a portion of the steps of a method 200 for sorting a data set of numbers is listed in FIG. 3. The steps may be performed in the order as shown in FIG. 3, or they may be performed in a different order. Furthermore, some steps may be performed concurrently as opposed to sequentially. In various embodiments, the steps may correspond to one or more code segments to be executed by the processing element 12.

In connection with step 201, an array of counters, C[c_idx], is established such that each counter corresponds to a value in a data set of numbers. The data set of numbers may include n numbers and m values with a range from Vmin, the minimum value in the range, to Vmax, the maximum value in the range. Each counter, which may be determined by the counter index, c_idx, may be correspond to the value by the relationship: c_idx=(N[n_idx]−Vmin)·A, where N[n_idx] is the value of any number in the range of values and A is a scalar that corresponds to the greatest number of decimal places, d, that any number possesses and may be given by the relationship: A=10^{d}.

In connection with step 202, the numbers of the data set are read and the counter is incremented that corresponds to the value of each number. The counter may be incremented by one as shown: C[c_idx]=C[c_idx]+1. In connection with step 203, the values are listed in sequential order, wherein each value occurs in the list according to the count of the corresponding counter. The values may be listed from Vmin to Vmax. The number of times each value appears in the list may be given by the count of the corresponding counter. For example, if the count of a counter is 10, then the corresponding value appears in the list 10 times. A value with a corresponding count of zero is not listed.

At least a portion of the steps of a method 300 for finding the Kth element of a data set of numbers is listed in FIG. 4. The method 300 may be used to determine the Median, when the Kth element equals n/2. The steps may be performed in the order as shown in FIG. 4, or they may be performed in a different order. Furthermore, some steps may be performed concurrently as opposed to sequentially. In various embodiments, the steps may correspond to one or more code segments to be executed by the processing element 12.

The method 300 may include steps 201 and 202 from the method 200 above. In connection with step 301, the count of each counter, C[c_idx], is accumulated in sequential order. The accumulation may start with counter C[0] and continue to counter C[1] and so forth. In connection with step 302, the accumulated count is compared with the desired Kth element after each counter. In connection with step 303, when the accumulated count equals or exceeds the Kth element, then the value corresponding to the current counter is determined. The value may be determined from the expression: c_idx/A+Vmin. If the Kth element equals n/2, then the value is the Median.

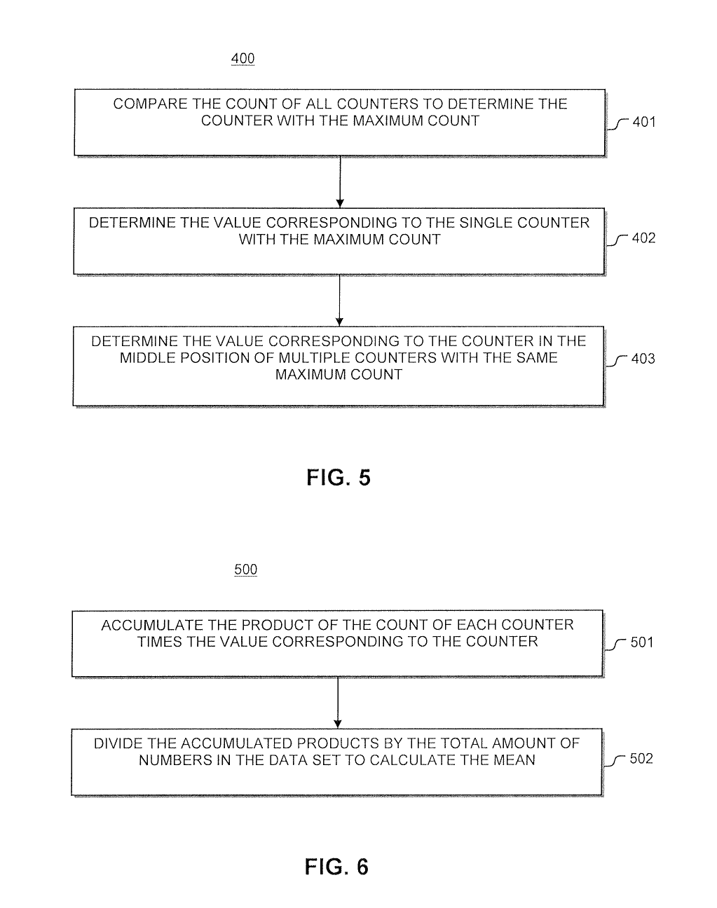

At least a portion of the steps of a method 400 for determining the Mode of a data set of numbers is listed in FIG. 5. The steps may be performed in the order as shown in FIG. 5, or they may be performed in a different order. Furthermore, some steps may be performed concurrently as opposed to sequentially. In various embodiments, the steps may correspond to one or more code segments to be executed by the processing element 12.

The method 400 may include steps 201 and 202 from the method 200 above. In connection with step 401, the count of all the counters, C[c_idx], is compared to determine the counter with the maximum count. A temporary intermediate variable, ModeMaxCount, may be created and assigned the maximum count in order to compare the count of all the counters, C[c_idx]. In connection with step 402, the value corresponding to the single counter with the maximum count is determined. Thus, if there is only one value that occurs in the data set more than the other values, then only one counter has the maximum count. The value of the Mode may be determined from the expression: c_idx/A+Vmin.

In connection with step 403, the value corresponding to the counter in the middle position of multiple counters with the same maximum count is determined. If no single value occurs more than the others in the data set, then there is more than one counter with the same maximum count. The counter that is in the middle of the sequential order of the counters may be determined to correspond to the value of the Mode. If there is an even number of counters with the same maximum count, then there are two counters that are in the middle of the sequential order of the counters. The value corresponding to either counter may be determined to be the Mode. Alternatively, a value that is the average of the values corresponding to the middle position counters may be determined to be the Mode.

At least a portion of the steps of a method 500 for determining the Mean of a data set of numbers is listed in FIG. 6. The steps may be performed in the order as shown in FIG. 6, or they may be performed in a different order. Furthermore, some steps may be performed concurrently as opposed to sequentially. In various embodiments, the steps may correspond to one or more code segments to be executed by the processing element 12.

The method 500 may include steps 201 and 202 from the method 200 above. In connection with step 501, the product of the count of each counter times the value corresponding to each counter is accumulated. The count may be given as: C[c_idx], and the value may be given as: c_idx/A+Vmin. The index, c_idx, may range from 0 to m−1. The accumulated products may be stored in a temporary variable, Sum. In connection with step 502, the accumulated products are divided by the total amount of numbers in the data set. Thus, the Mean equals Sum/n.

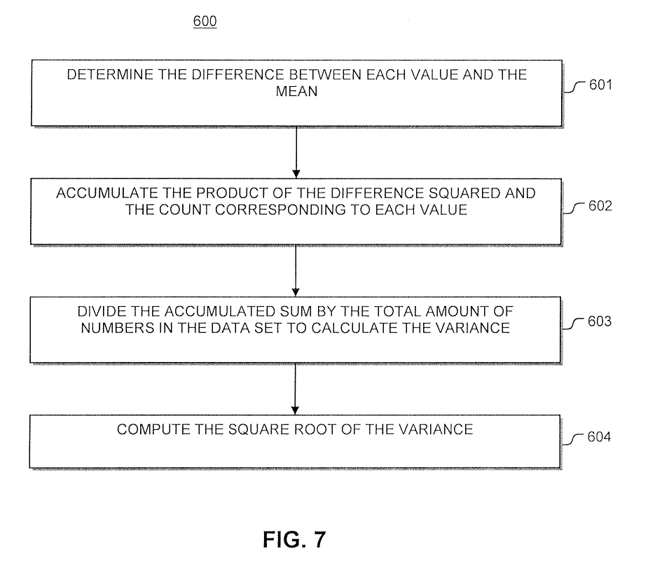

At least a portion of the steps of a method 600 for determining the Variance and the Standard Deviation of a data set of numbers is listed in FIG. 7. The steps may be performed in the order as shown in FIG. 7, or they may be performed in a different order. Furthermore, some steps may be performed concurrently as opposed to sequentially. In various embodiments, the steps may correspond to one or more code segments to be executed by the processing element 12.

The method 600 may include steps 201 and 202 from the method 200, and steps 501 and 502 from the method 500. In connection with step 601, the difference between each value and the Mean is determined. Each value may be derived from the relationship: c_idx/A+Vmin, where the index, c_idx, ranges from 0 to m−1. In connection with step 602, the difference is squared and multiplied by the count, C[c_idx], corresponding to each value. That product for all m values is then accumulated. In connection with step 603, the accumulated sum is divided by the total amount of numbers, n, in the data set to calculate the Variance. If the data set represents a sample from a larger population, then the Variance may be found by dividing the accumulated sum by the data set size minus one, n−1.

In connection with step 604, the square root of the Variance is computed to determine the Standard Deviation.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system comprising:
a memory element configured to store processing element executable instructions; and
a processing element configured to—
establish an array of counters such that each counter corresponds to each value in a data set of numbers, and
read the numbers and increment the counter corresponding to the value of each number.

2. The system of claim 1, wherein the data set of numbers includes a range of values and the processing element is configured to establish a counter for every value in the range.

3. The system of claim 1, wherein the processing element is further configured to list the values in sequential order wherein each value occurs in the list according to the count of the corresponding counter.

4. The system of claim 1, wherein the processing element is further configured to accumulate the count of each counter in sequential order.

5. The system of claim 4, wherein the processing element is further configured to compare the accumulated count with a first quantity after each counter.

6. The system of claim 5, wherein the processing element is further configured to determine the value corresponding to the counter when the accumulated count equals or exceeds the first quantity.

7. The system of claim 1, wherein the processing element is further configured to compare the count of all counters to determine the counter with the maximum count.

8. The system of claim 7, wherein the processing element is further configured to determine the value corresponding to the single counter with the maximum count.

9. The system of claim 7, wherein the processing element is further configured to determine the value corresponding to the counter in the middle position of multiple counters with the same maximum count.

10. The system of claim 1, wherein the processing element is further configured to accumulate the product of the count of each counter times the value corresponding to the counter.

11. The system of claim 10, wherein the processing element is further configured to divide the accumulated products by the total amount of numbers in the data set to calculate the mean.

12. The system of claim 11, wherein the processing element is further configured to determine the difference between each value and the mean.

13. The system of claim 12, wherein the processing element is further configured to accumulate the product of the difference squared and the count corresponding to each value.

14. The system of claim 13, wherein the processing element is further configured to divide the accumulated sum by the total amount of numbers in the data set to calculate the variance.

15. The system of claim 14, wherein the processing element is further configured to compute the square root of the variance.

16. A physical computer readable medium comprising a set of code segments to be executed by a processing element for sorting numbers of a data set, the physical computer readable medium comprising:
a code segment configured to establish an array of counters such that each counter corresponds to each value in the data set;
a code segment configured to read the numbers and increment the counter corresponding to the value of each number; and
a code segment configured to list the values in sequential order wherein each value occurs in the list according to the count of the corresponding counter.

17. A physical computer readable medium comprising a set of code segments to be executed by a processing element for determining a Kth element of a data set of numbers, the physical computer readable medium comprising:
a code segment configured to establish an array of counters such that each counter corresponds to a value in the data set;
a code segment configured to read the numbers and increment the counter corresponding to the value of each number;
a code segment configured to accumulate the count of each counter in sequential order;
a code segment configured to compare the accumulated count with a first quantity that corresponds to the Kth element after each counter; and
a code segment configured to determine the value corresponding to the counter when the accumulated count equals or exceeds the first quantity.

18. A physical computer readable medium comprising a set of code segments to be executed by a processing element for determining the Mode of a data set of numbers, the physical computer readable medium comprising:
a code segment configured to establish an array of counters such that each counter corresponds to a value in the data set;
a code segment configured to read the numbers and increment the counter corresponding to the value of each number;
a code segment configured to compare the count of all counters to determine the counter with the maximum count;
a code segment configured to determine the value corresponding to the single counter with the maximum count; and
a code segment configured to determine the value corresponding to the counter in the middle position of multiple counters with the same maximum count.

19. A physical computer readable medium comprising a set of code segments to be executed by a processing element for determining the Mean of a data set of numbers, the physical computer readable medium comprising:
a code segment configured to establish an array of counters such that each counter corresponds to a value in the data set;
a code segment configured to read the numbers and increment the counter corresponding to the value of each number;
a code segment configured to accumulate the product of the count of each counter times the value corresponding to the counter; and
a code segment configured to divide the accumulated products by the total amount of numbers in the data set.

20. A physical computer readable medium comprising a set of code segments to be executed by a processing element for determining the Variance and the Standard Deviation of a data set of numbers, the physical computer readable medium comprising:
a code segment configured to establish an array of counters such that each counter corresponds to a value in the data set;
a code segment configured to read the numbers and increment the counter corresponding to the value of each number;
a code segment configured to accumulate the product of the count of each counter times the value corresponding to the counter;
a code segment configured to divide the accumulated products by the total amount of numbers in the data set to calculate the mean;
a code segment configured to determine the difference between each value and the mean;
a code segment configured to accumulate the product of the difference squared and the count corresponding to each value;
a code segment configured to divide the accumulated sum by the total amount of numbers in the data set to calculate the variance; and
a code segment configured to compute the square root of the variance.
